(19) United States
(12) Patent Application Publication
(10) Pub. No.: US 2006/0125146 A1
(43) Pub. Date: Jun. 15, 2006

(54) Tire curing bladder of EPDM rubber and use thereof

(76) Inventor: Paul Harry Sandstrom, Cuyahoga Falls, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/008,020

(22) Filed: Dec. 9, 2004

(51) Int. Cl. B29C 35/00

(52) U.S. Cl. 264/313; 264/326; 425/43; 425/52

(57) ABSTRACT

The invention relates to expandable rubber bladders comprised of EPDM rubber for shaping and curing articles of conjugated diene-based elastomers such as pneumatic tires. The bladders are of a rubber composition comprised of resin cured EPDM rubber composition as a terpolymer of ethylene/propylene and a minor amount of a non-conjugated diene. The bladder composition may also contain castor oil, corn oil and/or soya-bean oil. The bladder composition may also contain at least one of graphite and polytetrafluoroethylene powder. Alternately, the EPDM-based bladder rubber composition may also contain a minor amount of a butyl-type of rubber. The invention also relates to a method of curing pneumatic rubber tires by utilizing such EPDM-based expandable rubber tire curing bladder in a tire curing press.

### FIELD OF THE INVENTION

The invention relates to expandable rubber bladders comprised of EPDM rubber for shaping and curing articles of conjugated diene-based elastomers such as pneumatic tires. The bladders are of a rubber composition comprised of resin cured EPDM rubber composition as a terpolymer of ethylene/propylene and a minor amount of a non-conjugated diene. The bladder composition may also contain castor oil, corn oil and/or soya-bean oil. The bladder composition may also contain at least one of graphite and polytetrafluoroethylene powder. Alternately, the EPDM-based bladder rubber composition may also contain a minor amount of a butyl-type of rubber. The invention also relates to a method of curing pneumatic rubber tires by utilizing such EPDM-based expandable rubber tire curing bladder in a tire curing press.

### BACKGROUND OF THE INVENTION

It is important for the interfacial surface of expandable tire curing rubber bladders to have adequate interfacial lubricity and sufficiently low adhesion properties between the bladder surface and the inner surface of the tire being vulcanized.

Conventionally a tire curing bladder is composed of a butyl rubber composition which contains castor oil as a lubricant which bleeds to the outer surface of the bladder to promote a continuing lubricity at the interface between the bladder surface and inner surface of the tire being cured. For example, see U.S. Pat. No. 3,031,423.

Use of corn oil as an internal tire cure butyl rubber bladder lubricant has also been proposed. For example, see U.S. Pat. No. 5,580,513.

Use of graphite as a lubricant (for example, see U.S. Pat. No. 5,538,218) and polytetrafluoroethylene powder as a lubricant (for example, see U.S. Pat. No. 5,728,311) have also been proposed for use in a butyl rubber tire curing bladder.

Even with an internal lubricant, such as castor oil or corn oil for the butyl rubber bladder composition, it is often desired to apply additional lubricant to the outer bladder surface to enhance the aforesaid interfacial lubrication such as, for example, a polysiloxane-based lubricant, a practice which is well known to those skilled in such art.

From an historical perspective, pneumatic rubber vehicle tires are conventionally produced by molding and curing a green or uncured, and unshaped tire, with the aid of an expandable rubber curing bladder, in a molding press. The green tire is pressed outwardly against a mold surface by means of an inner fluid-expandable tire curing bladder. By this method, the green tire is shaped against the outer mold surface which defines the tire tread pattern and configuration of the tire sidewalls. By application of heat and pressure, the tire is molded and cured with the suitable mold at elevated temperatures.

Historically, the expansion of the tire cure bladder is accomplished by application of internal pressure to the inner bladder cavity which is provided by a fluid such as gas, hot water and/or steam which also participates in the transfer of heat for the curing or vulcanization of the tire. The tire is then conventionally allowed to cool somewhat in the mold, sometimes aided by adding cold or cooler water to the internal bladder cavity. Then the mold is opened, the bladder is collapsed by removal of its internal fluid pressure and the tire is removed from the tire mold. Such use of tire curing bladders is well known to those having skill in such art.

By such practice, it is recognized that there is substantial relative movement at the interface between the outer contacting surface of the bladder and the inner surface of the tire during the expansion phase of the bladder. Likewise, there is considerable relative movement between the outer contacting surface of the bladder and the cured inner surface of the tire during the collapse and the stripping of the bladder from the tire after the tire has been molded and vulcanized.

By such practice, it is recognized that the bladder surface can tend to stick to a tire's inner surface after the tire is cured and during the bladder collapsing part of the tire cure cycle. This adhesion may cause roughening of the bladder surface if it is not controlled. This typically reduces bladder durability and can produce defective tires.

Accordingly, it is often desired to pre-coat the bladder surface, or to pre-coat the inner surface of the green or uncured tires with a lubricant which can also transfer to the bladder surface and, thereby, provide a degree of interfacial lubricity between the outer bladder surface and inner tire surfaces during the tire's molding and curing operation. Such lubricant has sometimes been referred to as a “bladder lubricant”, and can be of numerous formulations. A silicone polymer (e.g.: a polysiloxane) is often used as a bladder lubricant.

It is to be appreciated that the release of the tire from its curing bladder in an industrial manufacturing setting is intimately associated with both the phenomenon of release (to prevent sticking) and the phenomenon of lubrication (to enhance slipping) between the bladder and the adjacent tire surfaces. The release aspect refers to the basic ability to avoid adhesion, or release, and the aspect of lubrication relates to enhancing the ability of the surfaces to slip and enable a movement of the bladder with respect to the tire.

Butyl rubber is conventionally used for rubber compositions for tire curing bladders. The term “butyl rubber” as used herein refers to a copolymer of isobutylene and small amounts of conjugated diene monomers (e.g. isoprene) to provide sufficient unsaturation in the butyl rubber to allow it to be crosslinked through the resultant double bonds, unless otherwise indicated.

Halogenated copolymers (e.g. brominated copolymers) of isobutylene and para-methylstyrene are also sometimes used although usually not preferred. An example of such a brominated co-polymer is Exxpro™ from Exxon Chemical. A European patent application having Publication No. 0,344,021 describes a preparation of such brominated co-polymers.

As used herein, the term “butyl-type” rubber refers to such butyl rubber as well as halogenated butyl rubber (e.g. halogenated with chlorine or bromine such as for example chlorobutyl rubber and bromobutyl rubber) and as well as brominated copolymers of isobutylene and para methylstyrene, unless otherwise indicated.

It is desired herein, however, to provide a tire curing bladder comprised primarily of an alternate rubber composition.

In the description of this invention the term “phr” is sometimes used to refer to “parts per hundred parts by weight of rubber” for various ingredients in a rubber composition.

The terms “compound”, “compounded rubber” and “rubber composition” are intended to be interchangeable terms unless otherwise noted.

The terms “cure” and “vulcanize” are intended to be interchangeable terms unless otherwise noted.

### SUMMARY AND PRACTICE OF THE INVENTION

In accordance with this invention, an expandable tire curing bladder is provided of a cured composition comprised of, based upon parts by weight per 100 parts by weight rubber (phr):

(A) about 60 to about 100, alternately from about 70 to about 90, phr of EPDM rubber,

(B) from zero to about 40, alternately from about 10 to about 30, phr of butyl-type rubber selected from at least one of butyl rubber, halobutyl rubber and brominated copolymer of isobutylene and para methylstyrene, preferably butyl rubber comprised of from about 90 to about 99 weight percent repeat units from isobutylene and from 1 to abut 10 weight percent repeat units from conjugated diene comprised of isoprene;

wherein said tire curing bladder rubber composition is cured with a resin-based curative for said EPDM rubber and said butyl-type rubber, if used.

Accordingly, the curative for said cured expandable tire curing bladder is intended to be exclusive of sulfur and peroxide curatives.

In practice, said resin-based curative is comprised of a combination of polychloroprene rubber and phenol-formaldehyde resin, or combination of polychloroprene and brominated phenolic resin. Such resin curatives, particularly a combination of polychloroprene rubber and phenol-formaldehyde resin, are well known for use in curing butyl rubbers, although, in contrast, EPDM rubbers are conventionally cured with sulfur curatives.

In further accordance with this invention, in a curing press for shaping and curing an uncured pneumatic rubber tire which uses an expandable tire curing bladder to assist in shaping and curing said pneumatic rubber tire,

an improvement wherein said expandable tire curing bladder is said expandable tire curing rubber bladder of this invention.

In additional accordance with this invention, a method of shaping and curing an uncured pneumatic rubber tire in a mold using an expandable tire curing bladder to shape and cure said uncured pneumatic rubber tire, comprised of the sequential steps of:

(A) inserting an uncured pneumatic rubber tire into a curing press comprised of a rigid mold having an expandable tire curing bladder positioned therein, said rigid mold having at least one molding surface,

(B) expanding said expandable tire curing bladder by filling the internal portion of said expandable rubber bladder with a fluid to cause the expandable rubber bladder to outwardly expand against an inner surface of said uncured pneumatic rubber tire to force said uncured pneumatic tire against said molding surface(s) of said mold;

(C) curing said pneumatic rubber tire within said mold under conditions of heat (e.g. elevated temperature in a range of from about 150° C. to about 180° C.) and pressure (e.g. greater than atmospheric pressure) , and

(D) deflating said expandable tire curing bladder and removing said cured pneumatic rubber tire from said mold;

wherein said expandable tire curing bladder is said expandable tire curing rubber bladder of this invention.

In further accordance with said method, said inner surface of said uncured pneumatic rubber tire is comprised of a halobutyl-based rubber composition.

In additional accordance with said method, said expandable tire curing rubber bladder is comprised of said pre-cured EPDM-based rubber composition of this invention cured with a resin-based curative comprised of a combination of polychoroprene and phenol-formaldehyde resin exclusive of a sulfur curative, and said halobutyl-based rubber composition of said uncured pneumatic rubber tire liner contains a sulfur curative exclusive of a resin-based curative comprised of a combination of polychloroprene and phenol-formaldehyde resin.

In practice, said EPDM rubber is an elastomer comprised of units derived from ethylene, propylene and non-conjugated diene comprised of about 45 to about 75, preferably about 55 to about 65, weight percent (units derived from) ethylene, about 25 to about 50, preferably about 30 to about 40, weight percent (units derived from) propylene, and from about 1 to about 15, alternately from about 3 to about 10, weight percent (units derived from) non-conjugated diene, wherein said non-conjugated diene is preferably comprised of ethylidene norbornadiene, dicyclopentadiene or trans 1,4-hexadiene, with ethylidene norbornadiene being preferred. Such EPDM terpolymer rubbers are well known to those having skill in such art.

In practice, said butyl rubber, where used as a minor rubber component in the EPDM-based rubber composition for the expandable tire curing bladder of this invention and as hereinbefore discussed, is a copolymer of isobutylene and isoprene (containing about 1 to about 5 weight percent units derived from isoprene).

Alternatively, the bladder rubber composition for the expandable tire curing bladder of this invention additionally contains from about 2 to about 8 phr of at least one of castor oil, corn oil and soybean oil which are additives well known to those skilled in such art for use in butyl rubber-based tire curing bladders. For example, see hereinbefore referenced U.S. Pat. Nos. 3,031,423 and 5,580,513.

Alternatively, the bladder rubber composition for the expandable tire curing bladder of this invention, may, if desired, additionally contain from about 0.5 to about 10 phr of graphite and/or polytetrafluoroethylene which, may, where desired, enhance lubricity (reduce coefficient of friction) and reduce adhesion of the bladder surface to a tire innerliner surface during a tire cure operation. Such additives are well known by those having skill in such art for use in butyl rubber based tire curing bladders. For example, see hereinbefore referenced U.S. Pat. Nos. 5,538,218 and 5,728,311.

It is to be appreciated that, during a pneumatic rubber tire curing process in a suitable mold, the hot surface of the expandable tire curing bladder is pressed under considerable pressure and interfacial shear force against an uncured tire inner surface which is conventionally an uncured halobutyl rubber-based tire innerliner layer which contains a sulfur curative.

During such tire curing process, the interfacial surface (the surface of the rubber pressed against the surface of an uncured rubber tire), of a conventional resin pre-cured butyl rubber based tire curing bladder tends to adhere to a halobutyl rubber based tire innerliner layer as it cures with a sulfur curative in contact with the pre-cured tire cure bladder surface. To prevent such adhesive interfacial adherence, a lubricant (e.g. polysiloxane based lubricant) is pre-applied (e.g. by labor intensive spraying process) to the surface of the tire curing bladder and/or tire innerliner surface prior to the tire curing operation. Otherwise, the interfacial surfaces of the tire curing bladder and tire innerliner layer would tend to adhere and cure together and thereby become relatively inseparable.

Accordingly there is a motivation to reduce a need for such sprayed-on lubricant by less application of the lubricant or a reduced frequency of application of the lubricant.

It is considered herein, in view of experiments conducted in the Examples herein, that a resin cured EPDM-based rubber composition for an expandable tire cure bladder surface can provide less cured adhesion to a halobutyl-based tire innerliner layer even in the absence of lubricants applied to the interface between the rubber composition surfaces. This phenomenon is considered herein to be beneficial insofar as the potential extended longevity of the tire cure bladder is concerned as well as the envisioned reduction in frequency of labor intensive release coat applications.

It is believed herein that such phenomenon is due to a reduced compatibility of the surface of the resin cured EPDM-based curing bladder with the halobutyl rubber-based tire innerliner rubber composition (with its sulfur curative) which serves to reduce formation of interfacial cured adhesion between the surface of the pre-cured tire cure bladder and the internal surface of the cured rubber tire.

It is believed that the resin pre-cured EPDM based tire cure bladder, and the use of such bladder to cure tires having an interfacial rubber composition comprised of a halobutyl rubber-based tire innerliner is novel and is a substantial departure from past practice.

It is to be appreciated that the EPDM based rubber composition for the tire curing bladder is resin-cured instead of being sulfur or organic peroxide cured, particularly since EPDM-based rubber compositions are more conventionally cured with sulfur and/or organic peroxide curatives. Therefore use of resin cured EPDM-based rubber composition for an expandable tire cure bladder is considered herein to be a departure from conventional practice of use of sulfur or organic peroxide cured EPDM rubber compositions.

The resin curative for the EPDM-based rubber composition of the expandable tire curing bladder is conventionally composed of a combination of a small amount of polychloroprene rubber co-curative, sometimes referred to as a “neoprene rubber” which acts as a halogen source for activating the resin cure system, namely a form of a chlorine source, together with a phenol-formaldehyde resin co-curative. Such resin cure system for butyl rubber is well known to those having skill in such art. Alternatively, brominated phenolic resins such as SP-1055 from Schenectady International can also be used as a halogen source for the resin which may, if desired, be used in combination with the polychloroprene rubber for such purpose, together with the phenol-formaldehyde resin co-curative.

In practice, the polychloroprene rubber co-curative is conventionally counted toward the 100 parts by weight rubber of the EPDM based rubber composition even though it has the aforesaid separate function as being a halogen source for activating the resin cure system.

Resin curatives for curing the EPDM based tire cure bladder rubber composition may be used in amounts of, for example, from 1 to 10 phr and include conventional phenol-formaldehyde resins. Such resin cure systems for butyl rubber based bladder compositions are well known to those having skill in the art. For an example, see U.S. Pat. Nos. 3,031,423 and 5,728,311.

Antidegradants may, if desired, be added to the curing bladder composition to retard or prevent oxidative crosslinking or oxidative chain scission so that the modulus and fracture properties of the rubber are unchanged during exposure to oxidation especially at elevated temperatures. Antidegradants for rubber compositions in general and for EPDM and butyl rubber more specifically are well known to the art. Antidegradants (e.g. antioxidants and antiozonants) may be used, for example, in amounts ranging from about 0.1 to 5 phr. Antidegradants may include, for example, various monophenols, bisphenols, thiophenols, polyphenols, hydroquinone derivatives, phosphites, phosphate blends, thioesters, naphthylamines, diphenol amines as well as other diaryl amine derivatives, para-phenylenes, diamines, quinolines, and blended amines that have an antidegradant effect.

Various fillers are often incorporated into the curing bladder compositions. They may be used, for example, in amounts of about 20 to about 80 phr. A preferred reinforcing filler is carbon black. Silica may be used, if desired, in addition to the carbon black. Silicas are generally described as amorphous silicas, particularly precipitated silicas. Representative of various rubber reinforcing carbon blacks are, for example, according to standard ASTM designations, acetylene black (e.g. N990), N110, N121, N220, N231, N234, N242, N293, N299, N326, N330, N332, N339, N343, N347, N351, N358, N375, N472, N539, N550, N683, N754, and N765, although acetylene black and N347 and/or N220 carbon blacks are usually preferred. Preferably a major portion of the carbon black is acetylene black.

Various oils and waxes may be used in the EPDM-based curing bladder rubber formulation depending upon the compatibility of the oils and waxes with the EPDM-based rubber composition and the other components of the rubber formulation. They may be uniformly dispersed or they may desirably tend to phase separate (migrate to the surface) from the composition. Waxes include, for example, microcrystalline wax and paraffin wax. Oils include, for example, aliphatic, napthenic and aromatic types. Waxes can be used in conventional individual amounts such as, for example, from 1 to 5 or up to 10 phr. They are usually considered plasticizers and modulus modifiers. Fatty acids such as stearic acid, palmitic acid and oleic acid may be used in amounts from 0.1 to 7 phr with a range of about 0.2 to 6 phr sometimes being more preferred. Zinc oxide may be present, for example, in amounts from about 2 to 15 phr.

The curing bladder may be prepared, for example, by molding in an injection molding machine or a transfer molding machine. A cure Rheometer may be used to determine the approximate time to develop optimal cure at specific temperatures. The actual cure time will depend on heating rate and the gauge (thickness) of the curing bladder. The curing bladder will typically be of a toroidal shape.

The invention may be better understood by reference to the following examples in which the parts and percentages are by weight unless otherwise indicated.

### EXAMPLE I

Experiments were conducted to evaluate the feasibility of preparing a tire curing bladder comprised of resin cured EPDM rubber (e.g. combination of polychloroprene and phenol-formaldehyde resin co-curatives) instead of a resin cured butyl rubber.

Control (comparative) Sample A represents a butyl rubber based tire curing bladder rubber composition.

Experimental Samples B, C and D represent EPDM-based tire curing bladder rubber compositions.

Control Sample A and Experimental Samples B, C and D used various amounts and combinations of polychloroprene (Neoprene) and phenol-formaldehyde resin for the curative.

The rubber compositions were prepared by blending the ingredients, without the resin cure ingredients, in an internal rubber mixture in a non-productive mixing stage to a temperature of about 140° C. The resulting mixture was subsequently mixed with resin cure ingredients in a productive mixing stage to a temperature of about 100° C.

The rubber composition is cooled to below 40° C. between each of the non-productive mixing stages and prior to said productive mixing stage.

Materials for the rubber samples are illustrated in the following Table 1.

TABLE 1

| | Control | Experimental Samples | | |
|---|---|---|---|---|
| | A | B | C | D |
| Non Productive Mixing Step | | | | |
| Butyl rubber¹ | 95 | 0 | 0 | 0 |
| EPDM rubber² | 0 | 95 | 96 | 97 |
| Carbon black³ | 55 | 55 | 55 | 55 |
| Castor oil processing aid | 6 | 6 | 6 | 6 |
| Wax⁴ | 5 | 5 | 5 | 5 |
| Zinc oxide | 0.5 | 0.5 | 0.5 | 0.5 |
| Fatty acid⁵ | 0.5 | 0.5 | 0.5 | 0.5 |
| Productive Mixing Step | | | | |
| Neoprene co-curative⁶ | 5 | 5 | 4 | 3 |
| Phenolic resin co-curative⁷ | 9 | 5 | 4 | 3 |
| Zinc oxide | 4.5 | 4.5 | 4.5 | 4.5 |

¹Butyl rubber as Butyl 268 ™ from ExxonMobil as a copolymer comprised of isobutylene and isoprene
²EPDM rubber as Royalene 505 ™ from Crompton Company as a terpolymer comprised of 55 weight percent ethylene, 37 weight percent propylene and about 8 weight percent ethylidene norbornadiene
³Carbon black as combination of acetylene carbon black and ASTM N347 carbon black
⁴Wax as a microcrystalline wax
⁵Fatty acid as an industrial stearic acid comprised of stearic, palmitic and oleic acids
⁶Polychloroprene co-curative as Neoprene TRT ™ from du Pont de Nemours and Company
⁷Phenol formaldehyde resin co-curative as SP1044 ™ from Schenectady International.

The Samples were cured for about 30 minutes at a temperature of about 190° C.

Various physical properties are shown in the following Table 2.

TABLE 2

| | Con- | | | |
|---|---|---|---|---|
| | trol | Experimental Samples | | |
| | A | B | C | D |
| Rubber Compounds | | | | |
| Butyl rubber | 95 | 0 | 0 | 0 |
| EPDM rubber | 0 | 95 | 96 | 97 |
| Neoprene co- | 5 | 5 | 4 | 3 |
| curative | | | | |
| Phenolic resin co- | 9 | 5 | 4 | 3 |
| curative | | | | |
| Total neoprene and | 14 | 10 | 8 | 6 |
| phenolic resin | | | | |
| Ratio phenolic | 1.8 | 1.0 | 1.0 | 1.0 |
| resin/neoprene | | | | |
| Rheometer at 190° | | | | |
| C. (MDR)¹ | | | | |
| Maximum torque (dNm) | 12.41 | 22.94 | 21.45 | 18.91 |
| Minimum torque (dNm) | 2.34 | 2.46 | 2.51 | 2.68 |
| Delta torque (dNm) | 10.07 | 20.48 | 18.94 | 16.23 |
| T90 minutes | 22.3 | 11.9 | 11 | 11.9 |
| (ATS)² | | | | |
| Tensile strength | 10.7 | 16.6 | 17.7 | 16.1 |
| (MPa) | | | | |
| Elongation at | 566 | 426 | 477 | 492 |
| break (%) | | | | |
| 300% modulus, | 6.58 | 12.63 | 11.52 | 9.52 |
| ring (MPa) | | | | |
| Hardness, Shore A | | | | |
| 23° C. | 66 | 75 | 74 | 75 |
| 100° C. | 53 | 67 | 66 | 65 |
| Rebound | | | | |
| 23° C. | 12 | 47 | 49 | 51 |
| 100° C. | 49 | 56 | 55 | 52 |
| Tear Strength³ | | | | |
| 23° C., N | 157 | 118 | 94 | 120 |
| RPA, 100° C., 1 Hz⁴ | | | | |
| G′ at 10% | 633 | 1365 | 1288 | 1263 |
| strain (kPa) | | | | |
| Tan delta at | 0.307 | 0.246 | 0.279 | 0.308 |
| 10% strain | | | | |
| ¹Data obtained according to Moving Die Rheometer (MDR) instrument, model MDR-2000 by Alpha Technologies, used for determining cure characteristics of elastomeric materials, such as for example Torque, T90 etc. | | | | |
| ²Data obtained according to Automated Testing System (ATS) instrument by the Instron Corporation which incorporates six tests in one system. Such instrument may determine ultimate tensile, ultimate elongation, modulii, etc. Data reported in the Table is generated by running the ring tensile test station which is an Instron 4201 load frame. | | | | |
| ³Data obtained according to a peel strength adhesion (tear strength) test to determine interfacial adhesion between two samples of a rubber composition. In particular, such interfacial adhesion is determined by pulling one rubber composition away from the other at a right angle to the untorn test specimen with the two ends of the rubber | | | | |
| # compositions being pulled apart at a 180° angle to each other using an Instron instrument. The area of contact at the interface between the rubber samples is facilitated by placement of a plastic film (e.g. Mylar ™ film) between the samples with a cut-out window in the film to enable the two rubber samples to contact each other | | | | |
| # following which the samples are vulcanized together and the resultant composite of the two rubber compositions used for the peel strength (tear strength) test. For example, an uncured rubber sample is prepared by milling the rubber composition and applying a suitable removable film (e.g. a polyethylene film) to each of the two sides of the milled rubber. | | | | |
| # Two uncured rubber samples are cut from the milled rubber composition into a size 150 × 150 × 2.4 mm thickness. The polyethylene film is removed from one side of a first sample and a fabric backing (e.g. polyester cord fabric) is stitched to that side with a roller in order to provide dimensional stability for the rubber sample. | | | | |
| # The polyethylene film is removed from the other side of the first sample and a separator sheet of the Mylar film (with a 5 mm wide × 50 mm long cut out window) is placed and centered on the exposed rubber surface of the sample. The polyethylene film is removed from one side of the second sample. | | | | |
| # The first and second samples are pressed together with the Mylar film therebetween and stitched together with a roller in a manner that the window in the Mylar film allows the samples to contact each other. The composite of the two samples is placed in the bottom cavity of a preheated diaphragm based curing mold. | | | | |
| # The composite is covered with a sheet of cellophane film. An expandable bladder is positioned onto the cellophane film within the mold and a metal top cover is positioned over the curing bladder to form an assembly thereof, all within the mold. The mold which contains the assembly is placed in a preheated curing press. | | | | |
| # The press is closed over the mold and an air pressure of 6.9 bar (100 psi) is applied to the expandable bladder with the curing mold through an air line fixture on the curing mold. A cure temperature of 150° C. is used. After curing for about 32 minutes, the air line to the mold is shut off, the mold removed from the press, | | | | |
| # followed by removal of the top plate, bladder. The composite is removed from the mold and allowed to cool to about 23° C. and the cellophane removed. From the cured composite, 25 mm (1 inch) test strips are cut so that the included Mylar film, with its aforesaid window, is located as near to the middle of the test strip as reasonably possible. | | | | |
| # A portion of the first and second samples at an open end of the test strip (the open end is composed of the first and second rubber samples which are separated by the Mylar film so that a significant portion of the rubber samples are not cured together) are pulled apart to expose open ends of each of the rubber samples and the exposed Mylar film strip is cut off. | | | | |
| # The pulled-apart ends of the samples are placed into grips of the Instron test machine. The peel adhesion (tear strength) test is conducted at a crosshead speed of the Instron instrument at a of rate of 500 mm/min (20 inches/min) at 95° C. The force to pull apart the portion of the samples cured together within the aforesaid Mylar window | | | | |
| # is obtained from the data under the load deflection curve reported by the Instron instrument and is expressed as N-cm. | | | | |

⁴Data obtained according to Rubber Process Analyzer as RPA 2000 ™ instrument by Alpha Technologies, formerly the Flexsys Company and formerly the Monsanto Company. References to an RPA 2000 instrument may be found in the following publications: H. A. Palowski, et al, Rubber World, June 1992 and January 1997, as well as Rubber & Plastics News, April 26 and May 10, 1993.

From Table 2 it can be seen that the EPDM rubber composition can be suitably cured with the resin cure system used for the butyl rubber control rubber composition.

This is considered herein to be significant because it demonstrates that a suitable temperature resistant crosslinking, resin-based curative, network can be formed with a stable substantially saturated type EPDM type of terpolymer rubber.

From Table 2 it can also be seen that the cured properties of the EPDM based rubber composition can be somewhat equivalent to the illustrated cured properties of the butyl rubber based control rubber Sample A with an adjustment of the levels of the resin-based co-curatives.

The achievable similarity of the illustrated cured properties of the resin cured EPDM and butyl rubber-based rubber compositions is considered herein to be significant because it is believed herein that the resin pre-cured EPDM-based rubber composition should be less compatible than the resin pre-cured butyl rubber composition with the halobutyl rubber-based tire innerliner rubber composition and therefore have a reduced tendency to co-cure at the interface.

### EXAMPLE II

Additional experiments were conducted to further evaluate the feasibility of preparing a tire curing bladder comprised of resin cured EPDM rubber (e.g. combination of polychloroprene and phenol-formaldehyde resin co-curatives) instead of a resin cured butyl rubber.

Control (comparative) Sample E represents a butyl rubber based tire curing bladder rubber composition.

Experimental Samples F through J represent an EPDM based tire curing bladder rubber composition.

Experimental Samples K and L represent a blend of EPDM and butyl rubber for an experimental tire curing bladder rubber composition.

The Samples were prepared in the manner of Example I.

Materials for the rubber samples are illustrated in the following Table 3.

TABLE 3

| | Con- | | | | | | | |
|---|---|---|---|---|---|---|---|---|
| | trol | Experimental Samples | | | | | | |
| | E | F | G | H | I | J | K | L |
| Non Productive | | | | | | | | |
| Mixing Step | | | | | | | | |
| Butyl rubber¹ | 95 | 0 | 0 | 0 | 0 | 0 | 15 | 30 |
| EPDM rubber² | 0 | 96 | 98 | 96 | 98 | 96 | 81 | 66 |
| Carbon black³ | 55 | 55 | 55 | 55 | 55 | 55 | 55 | 55 |
| Castor oil | 6 | 6 | 6 | 6 | 6 | 6 | 6 | 6 |
| Wax⁴ | 5 | 5 | 5 | 5 | 5 | 5 | 5 | 5 |
| Zinc oxide | 0.5 | 0.5 | 0.5 | 0.5 | 0.5 | 0.5 | 0.5 | 0.5 |
| Fatty acid⁵ | 0.5 | 0.5 | 0.5 | 0.5 | 0.5 | 0.5 | 0.5 | 0.5 |
| Productive | | | | | | | | |
| Mixing Step | | | | | | | | |
| Neoprene | 5 | 4 | 2 | 4 | 2 | 4 | 4 | 4 |
| co-curative⁶ | | | | | | | | |
| Phenolic resin | 9 | 4 | 4 | 2 | 2 | 4 | 4 | 4 |
| co-curative⁷ | | | | | | | | |
| Zinc oxide | 4.5 | 4.5 | 4.5 | 4.5 | 4.5 | 2.5 | 4.5 | 4.5 |

The footnotes for the above Table 3 are the same as the footnotes for previous Table 1.

The Samples were cured for 30 minutes at a temperature of about 190° C.

Various physical properties are reported in the following Table 4.

TABLE 4

| | E | F | G | H | I | J | K | L |
|---|---|---|---|---|---|---|---|---|
| Rubber Compounds | | | | | | | | |
| Butyl rubber | 95 | 0 | 0 | 0 | 0 | 0 | 15 | 30 |
| EPDM rubber | 0 | 96 | 98 | 96 | 98 | 96 | 81 | 66 |
| Neoprene co-curative | 5 | 4 | 2 | 4 | 2 | 4 | 4 | 4 |
| Phenolic resin co-curative | 9 | 4 | 4 | 2 | 2 | 4 | 4 | 4 |
| Zinc oxide | 5 | 5 | 5 | 5 | 5 | 3 | 5 | 5 |
| Total neoprene and phenolic resin | 14 | 8 | 6 | 6 | 4 | 8 | 8 | 8 |
| Ratio of phenolic resin/neoprene | 1.8 | 1 | 2 | 0.5 | 1 | 1 | 1 | 1 |
| Rheometer at 190° C. (MDR)¹ | | | | | | | | |
| Maximum torque (dNm) | 14.11 | 21.13 | 16.5 | 15.64 | 16.31 | 23.37 | 22.63 | 19.95 |
| Minimum torque (dNm) | 2.64 | 2.72 | 2.29 | 2.79 | 3.02 | 2.87 | 2.93 | 2.91 |
| Delta torque (dNm) | 11.47 | 18.41 | 14.21 | 12.85 | 13.29 | 20.5 | 19.69 | 17.04 |
| T90 minutes | 24.3 | 16.7 | 40.9 | 16.44 | 19.52 | 14.16 | 15.56 | 15.75 |
| (ATS)² | | | | | | | | |
| Tensile strength (MPa) | 11 | 17.4 | 13.7 | 14.4 | 15.8 | 18.3 | 15.7 | 14.2 |
| Elongation at break (%) | 556 | 519 | 644 | 563 | 599 | 458 | 420 | 411 |
| 300% modulus, ring (MPa) | 7.19 | 9.78 | 5.82 | 6.89 | 7.17 | 12.77 | 12.38 | 11.73 |
| Hardness, Shore A | | | | | | | | |
| 23° C. | 69 | 75 | 74 | 75 | 76 | 76 | 76 | 74 |
| 100° C. | 55 | 64 | 58 | 60 | 61 | 67 | 66 | 65 |
| Rebound | | | | | | | | |
| 23° C. | 12 | 50 | 52 | 52 | 52 | 50 | 44 | 38 |
| 100° C. | 45 | 54 | 48 | 50 | 48 | 57 | 58 | 56 |
| Tear Strength³ | | | | | | | | |
| 23° C., N | 140 | 129 | 228 | 178 | 171 | 99 | 93 | 78 |
| RPA, 100° C., 1 Hz⁴ | | | | | | | | |
| G′ at 10% strain (kPa) | 659 | 976 | 536 | 1001 | 899 | 1276 | 1049 | 1021 |
| Tan delta at 10% strain | 0.346 | 0.423 | 0.638 | 0.421 | 0.5 | 0.327 | 0.422 | 0.442 |
| Pierced groove flex test | | | | | | | | |
| (mm at 60 minutes)⁵ | | | | | | | | |
| 60 minutes (mm) | 14.2 | 25.4 | 24.9 | 17.7 | 21.7 | 25.4 | 25.4 | 25.4 |

Footnotes 1 through 4 for the above Table 4 are the same as the footnotes for previous Table 2.
⁵Comparative pierced groove flex test for the representative Samples are similar to ASTM D813 and is discussed in U.S. Pat. No. 6,013,218 in column 12.

Footnotes 1 through 4 for the above Table 4 are the same as the footnotes for previous Table 2.

From Table 2 it can be seen that the state of cure and rate of cure, as indicated by the delta torque and T90 values, respectively, can be modified by adjusting the level of the co-curatives.

This is considered herein to be significant because a suitable balance of cure rate, stress-strain and tear strength properties can be obtained by adjusting the level of the co-curatives.

From Table 4 it can also be seen that a minor amount of butyl rubber (Samples K and L) can be used in the EPDM-based rubber composition.

### EXAMPLE III

Additional experiments were conducted to further evaluate the feasibility of preparing a tire curing bladder comprised of resin cured EPDM rubber (e.g. combination of polychloroprene and phenol-formaldehyde resin co-curatives) instead of a resin cured butyl rubber.

Control (comparative) Sample M represents a butyl rubber based tire cure bladder rubber composition.

Experimental Samples N and O represent an EPDM based tire cure bladder rubber compositions using different EPDMs.

The Samples were prepared in the manner of Example I.

Materials for the rubber samples are illustrated in the following Table 5.

TABLE 5

| | Control | Experimental Samples | |
|---|---|---|---|
| | M | N | O |
| Non Productive Mixing Step | | | |
| Butyl rubber¹ | 95 | 0 | 0 |
| EPDM rubber² | 0 | 96.2(a) | 96.2(b) |
| Carbon black³ | 55 | 55 | 55 |
| Castor oil | 6 | 6 | 6 |
| Wax⁴ | 5 | 5 | 5 |
| Zinc oxide | 0.5 | 0.5 | 0.5 |
| Fatty acid⁵ | 0.5 | 0.5 | 0.5 |
| Teflon (polytetrafluoroethylene)⁸ | 0 | 0 | 5 |
| Graphite⁹ | 0 | 0 | 5 |
| Productive Mixing Step | | | |
| Neoprene co-curative⁶ | 5.0 | 3.8 | 3.8 |
| Phenolic resin co-curative⁷ | 9.0 | 3.8 | 3.8 |
| Zinc oxide | 4.5 | 4.5 | 4.5 |

(a)EPDM as Royalene 505 ™from Crompton reportedly comprised of about 55 weight percent units derived from ethylene, about 37 weight percent units derived from propylene and about 8 weight percent units derived from ethylidine norbornadiene
(b)EPDM as Royalene 502 ™ from Crompton reportedly comprised of about 61 weight percent units derived from ethylene, about 35 percent units derived from propylene and about 4 weight percent units derived from ethylidine norbornadiene.
⁸Teflon, (polytetrafluoroethylene), as Polymist F-5A ™ from Sovay Solexis Incorporated
⁹Graphite as Synthetic Graphite 1442 ™ from Asbury Graphite

The Samples were cured for about 30 minutes at a temperature of about 190° C.

Various physical properties are reported in the following Table 6.

TABLE 6

| | Control | Experimental Samples | |
|---|---|---|---|
| | M | N | O |
| Rubber Compound | | | |
| Butyl rubber | 95 | 0 | 0 |
| EPDM rubber | 0 | 96.2(a) | 96.2(b) |
| Neoprene co-curative | 5 | 3.8 | 3.8 |
| Phenolic resin co-curative | 9 | 3.8 | 3.8 |
| Teflon (polytetrafluoroethylene) | 0 | 0 | 5 |
| Graphite | 0 | 0 | 5 |
| Total neoprene and phenolic resin | 14 | 7.6 | 7.6 |
| Ratio of phenolic resin/neoprene | 1.8/1 | 1/1 | 1/1 |
| Rheometer at 190° C. (MDR)¹ | | | |
| Maximum torque (dNm) | 12.51 | 21.08 | 21.66 |
| Minimum torque (dNm) | 2.57 | 2.78 | 3 |
| Delta torque (dNm) | 9.94 | 18.3 | 18.66 |
| T90 minutes | 21.4 | 16 | 28 |
| Stress-Strain, Cured Sample at | | | |
| 28 minutes at 150° C. (ATS)² | | | |
| Tensile strength (MPa) | 10.4 | 10.9 | 10.9 |
| Elongation at break (%) | 610 | 380 | 490 |
| 300% modulus, ring (MPa) | 5.8 | 9.1 | 7.3 |
| Hardness, Shore A | | | |
| 23° C. | 65 | 76 | 78 |
| 100° C. | 53 | 65 | 65 |
| Rebound | | | |
| 23° C. | 12 | 51 | 55 |
| 100° C. | 47 | 51 | 51 |
| Tear Strength (Peel Adhesion)³ | | | |
| (a) 23° C., N, to self | 182 | 144 | 131 |
| (b) 23° C., N, to halobutyl rubber | 40 | 4 | 0 |
| RPA, 100° C., 1 Hz⁴ | | | |
| G′ at 10% strain (kPa) | 692 | 1199 | 814 |
| Tan delta at 10% strain | 0.28 | 0.34 | 0.58 |
| Pierced groove flex test | | | |
| (mm at 15 minutes)⁵ | | | |
| 15 minutes (mm) | 7.2 | 22.2 | 8.1 |

Footnotes 1 through 5 for the above Table 6 are the same as the footnotes for previous Tables 2 and 4, except that for footnote 3.

For footnote 3(b), data is also reported for adhesion of a pre-cured specimen of Control (Comparative) Sample M, Experimental Sample N and Experimental Sample O, individually, pressed against uncured halobutyl-based rubber composition similar to pneumatic tire innerliner layer and the assembly of the specimens then cured together. U.S. Pat. No. 6,013,218 is descriptive of a tire preparation process using a tire curing process in which an expandable tire curing bladder is expanded against an inner surface of an uncured pneumatic rubber tire.

From Table 6 it can be seen that most of the significant cured properties of Samples N and O are similar to the cured properties of the Control Sample M.

However, in Table 6 it is readily seen that a significant reduction of adhesion (tear strength) of the cured EPDM based rubber composition to an uncured halobutyl-based tire innerliner type of rubber composition occurred for Sample N and particularly occurred for Sample O which contained the inclusion of the teflon and graphite.

This is considered herein to be significant because the significantly reduced adhesion (tear strength) shown by Samples N and O, compared to Control Sample M, is predictive of and should provide a longer tire cure bladder service life for an expandable tire curing bladder comprised of such resin cured EPDM-based rubber composition and promote a reduction in labor intensive frequency of application of release coatings applied to the tire curing bladder and/or tire innerliner interfacial surfaces prior to the tire curing operation.

While certain representative embodiments and details have been shown for the purpose of illustrating the invention, it will be apparent to those skilled in this art that various changes and modifications may be made therein without departing from the spirit or scope of the invention.

What is claimed is:

1. An expandable tire curing bladder of cured rubber composition comprised of, based upon parts by weight per 100 parts by weight rubber (phr):
(A) about 60 to about 100 phr of EPDM rubber,
(B) from zero to about 40 phr of butyl-type rubber selected from at least one of butyl rubber, halobutyl rubber and brominated copolymer of isobutylene and para methylstyrene,
wherein said tire curing bladder rubber composition is cured with a resin-based curative for said EPDM rubber and said butyl-type rubber, if used.

2. The expandable tire curing bladder of claim 1 wherein said curative for said tire curing bladder rubber composition is exclusive of sulfur and peroxide curatives.

3. The expandable tire curing bladder of claim 1 wherein said EPDM rubber is an elastomer comprised of units derived from ethylene, propylene and non-conjugated diene comprised of about 45 to about 75 weight percent units derived from ethylene, about 25 to about 50 weight percent units derived from propylene, and from about 1 to about 15 weight percent units derived from a non-conjugated diene comprised of ethylidene norbornadiene, dicyclopentadiene or trans 1,4-hexadiene.

4. The expandable tire curing bladder of claim 3 wherein said non-conjugated diene for said EPDM rubber is ethylidene norbornadiene.

5. The expandable tire curing bladder of claim 1 wherein said resin curative is comprised of a combination of polychloroprene rubber and phenol-formaldehyde resin.

6. The expandable tire curing bladder of claim 1 wherein said resin curative is comprised of a combination of polychloroprene rubber and brominated phenolic resin.

7. The expandable tire curing bladder of claim 1 which is comprised of, based upon parts by weight per 100 parts by weight rubber (phr):
(A) about 70 to about 90 phr of EPDM rubber,
(B) about 10 to about 30, phr of butyl rubber comprised of from about 90 to about 99 weight percent repeat units from isobutylene and from 1 to about 10 weight percent repeat units from conjugated diene comprised of isoprene, and
(C) at least one resin-based curative for said EPDM rubber and butyl rubber;
wherein said EPDM rubber is comprised of about 55 to about 65 weight percent units derived from ethylene, about 30 to about 40 weight percent units derived from propylene, and from about 3 to about 10 weight percent units derived from non-conjugated diene, wherein said non-conjugated diene is an ethylidene norbornadiene;
wherein said resin curative is comprised of a combination of polychloroprene rubber and phenol-formaldehyde resin.

8. The expandable tire curing bladder of claim 1 wherein said EPDM-based tire curing bladder composition contains from about 2 to about 8 phr of at least one of castor oil, corn oil and soybean oil.

9. The expandable tire curing bladder of claim 1 wherein said EPDM-based tire curing bladder composition contains from about 0.5 to about 10 phr of graphite and/or polytetrafluoroethylene.

10. The expandable tire curing bladder of claim 1 wherein said EPDM-based tire curing bladder composition contains from about 0.5 to about 10 phr of graphite.

11. The expandable tire curing bladder of claim 1 wherein said EPDM-based tire curing bladder composition contains from about 0.5 to about 10 phr of polytetrafluoroethylene.

12. The expandable tire curing bladder of claim 8 wherein said EPDM-based tire curing bladder composition contains from about 0.5 to about 10 phr of graphite and/or polytetrafluoroethylene.

13. In a curing press for shaping and curing an uncured pneumatic rubber tire which uses an expandable tire curing bladder to assist in shaping and curing said pneumatic rubber tire;
an improvement wherein said expandable tire curing bladder is said expandable tire curing rubber bladder of claim 1.

14. A method of shaping and curing an uncured pneumatic rubber tire in a mold using an expandable rubber bladder to shape and cure said uncured pneumatic rubber tire, comprised of the sequential steps of:
(A) inserting an uncured pneumatic rubber tire into a curing press comprised of a rigid mold having an expandable tire curing bladder positioned therein, said rigid mold having at least one molding surface,
(B) expanding said expandable rubber bladder by filling the internal portion of said expandable tire cure rubber bladder with a fluid to cause the expandable rubber bladder to expand outwardly against an inner surface of said uncured pneumatic rubber tire to force said uncured pneumatic tire against said molding surface(s) of said mold;
(C) curing said pneumatic rubber tire within said mold under conditions of heat (e.g. elevated temperature in a range of from about 150° C. to about 180° C.) and pressure (e.g. greater than atmospheric pressure), and
(D) deflating said expandable tire curing bladder and removing said cured pneumatic rubber tire from said mold;
wherein said expandable tire curing bladder is said expandable tire curing bladder of claim 1.

15. The method of claim 14 wherein said inner surface of said uncured pneumatic rubber tire is comprised of a halobutyl-based rubber composition.

16. The method of claim 15 wherein said expandable tire curing bladder is comprised of said pre-cured EPDM-based rubber composition cured with a resin curative comprised of a combination of polychloroprene and phenol-formaldehyde resin exclusive of a sulfur curative and/or peroxide curative and said halobutyl-based rubber composition of said uncured pneumatic rubber tire liner contains a sulfur curative exclusive of a resin curative comprised of polychloroprene and/or phenol-formaldehyde resin.

17. The method of claim 16 wherein said expandable tire curing bladder is composed of a cured rubber composition comprised of, based upon parts by weight per 100 parts by weight rubber (phr):
(A) about 70 to about 90 phr of EPDM rubber,
(B) about 10 to about 30, phr of butyl rubber comprised of from about 90 to about 99 weight percent repeat units from isobutylene and from 1 to about 10 weight percent repeat units from conjugated diene comprised of isoprene, and
(C) at least one resin-based curative for said EPDM rubber and butyl rubber;
wherein said EPDM rubber is comprised of about 55 to about 65 weight percent units derived from ethylene, about 30 to about 40 weight percent units derived from propylene, and from about 3 to about 10 weight percent units derived from non-conjugated diene, wherein said non-conjugated diene is an ethylidene norbornadiene;
wherein said resin curative is comprised of a combination of polychloroprene rubber and phenol-formaldehyde resin, and
wherein said inner surface of said uncured pneumatic rubber tire is comprised of a halobutyl-based rubber composition.

18. The method of claim 15 wherein said expandable tire curing bladder composition contains:
(A) from about 2 to about 8 phr of at least one of castor oil, corn oil and soybean oil and/or
(B) from about 0.5 to about 10 phr of graphite and/or polytetrafluoroethylene.

19. The method of claim 16 wherein said expandable tire curing bladder composition contains:
(A) from about 2 to about 8 phr of at least one of castor oil, corn oil and soybean oil and/or
(B) from about 0.5 to about 10 phr of graphite and/or polytetrafluoroethylene.

20. The method of claim 17 wherein said expandable tire curing bladder composition contains:
(A) from about 2 to about 8 phr of at least one of castor oil, corn oil and soybean oil and/or
(B) from about 0.5 to about 10 phr of graphite and/or polytetrafluoroethylene.
